(19) United States
(12) Patent Application Publication
(10) Pub. No.: US 2007/0076127 A1
(43) Pub. Date: Apr. 5, 2007

(54) Image processing apparatus and an image processing program

(75) Inventors: Takaaki Abe, Hirakata City (JP); Akihiro Maenaka, Kadoma City (JP); Norikazu Tsunekawa, Hirakata City (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi City (JP)

(21) Appl. No.: 11/528,585

(22) Filed: Sep. 28, 2006

(30) Foreign Application Priority Data
Sep. 30, 2005 (JP) 2005-289357

(51) Int. Cl. H04N 9/68

(52) U.S. Cl. 348/645

(57) ABSTRACT

The objective of the present invention is to offer an image processing apparatus, or an image processing program which can generate natural images. In the invention, a chroma saturation correction coefficient is determined according to the chroma saturation distribution properties of an input image, and the chroma saturation correction is executed based on the determined coefficient. Therefore, a suitable chroma saturation correction can be performed to various input images. To achieve above objective, in the image processor 100, the chroma saturation distribution properties calculator 101 calculates chroma saturation distribution properties from an input image signal. The chroma saturation correcting gain calculator 102 calculates the standard chroma saturation correcting gain, which is a coefficient used as a standard for calculating the chroma saturation correction quantity based on the properties of the input image signal. The chroma saturation correction executor 103 corrects the chroma saturation based on the calculated correcting gain.

### RELATED APPLICATION

The priority application number Japanese patent application No.2005-289357 upon which this patent is based is hereby incorporated by reference.

### BACKGROUND OF THE INVENTION

1. Field of the Invention

The present invention relates to an image processing apparatus and an image processing program, for performing a chroma saturation correction of the input image based on a chroma saturation distribution of the image.

2. Description of the Related Art

Conventionally, an image processing apparatus for correcting the color of an input image according to properties of the hue, the chroma saturation, or the lightness of the input image has been developed.

However, these image processing apparatus may output unnatural images because of not having a high precision of correction.

For example, according to a technology indicated in publication of a Japanese patent application 2001-230941 (publication number), chroma saturation of an input image is corrected by controlling a chroma saturation enhancing coefficient based on an average chroma saturation value acquired from a histogram of the chroma saturation of the input image. According to such technology, a suitable correction is possible if the input images have the chroma saturation distribution like that shown in FIG. 14, where the distribution is concentrating on adjacent spaces of the average chroma saturation value.

However, even if the average chroma saturation value of the image is the same as the distribution shown in FIG. 14, the saturation distribution of the image may be spread to low and high chroma saturation areas, which are separated from the average, as shown in FIG. 15. In such case, if the same chroma saturation correction as in the case of FIG. 14 is performed, some color may be crushed in the high chroma saturation area, and some color may be deepen in the low chroma saturation area. As a result, there is a problem that the image may become an unnatural image, after the correction.

### SUMMARY OF THE INVENTION

The object of present invention is to offer an image processing apparatus and an image processing program performing a suitable chroma saturation correction to various input images, and generating natural images. In order to achieve the object, the correction is performed based on a chroma saturation correction coefficient which is determined according to properties of the chroma saturation distribution of an input image.

In present invention, an image processing apparatus performing a chroma saturation correction of an input image includes the following structures:

(a) A chroma saturation distribution properties calculator for calculating an average and a variation of the chroma saturation of an input image,

(b) A chroma saturation correction coefficient calculator for calculating a chroma saturation correction coefficient based on the average and the variation of the chroma saturation, and,

(c) A chroma saturation correction executor for executing a chroma saturation correction to the input image based on the calculated correction coefficient.

According to the image processing apparatus above, the chroma saturation correction quantity is calculated considering not only an average of the chroma saturation of an input image but also a distribution of the chroma saturation. Therefore, even if the averages are the same, a different chroma saturation correction can be performed to the input images.

Preferably, the chroma saturation correction coefficient calculator calculates a first coefficient based on the variation of the chroma saturation, calculates a second coefficient calculated based on the average of the chroma saturation and then calculates a correction coefficient based on the first coefficient and the second coefficient.

Preferably, said chroma saturation correction coefficient calculator decreases the first coefficient as the variation increases, if the variation is beyond a predetermined value.

Preferably, the chroma saturation correction coefficient calculator judges whether the input image belongs to a chromatic color area, or an achromatic color area, based on the average of the chroma saturation. When it is judged that the input image belongs to the achromatic color area, the second coefficient is increased as the average increase. When it is judged that the input image belongs to the chromatic color area, the second coefficient is decreased as the average increases. The coefficient calculator may determine the largest value of the second coefficient based on the first coefficient.

Preferably, the chroma saturation correction coefficient calculator calculates a standard chroma saturation correction coefficient based on the average and the variation of the chroma saturation. Preferably, the chroma saturation correction executor calculates the correction coefficient for each pixel based on the standard correction coefficient and the chroma saturation of each pixel. Also, the executor performs the correction for each pixel, based on the calculated correction coefficient.

The above image processing apparatus bases the correction upon the correction coefficient calculated by the correction coefficient calculator, and further can adjust the correction suitable for each pixel according to the chroma saturation of each pixel.

Preferably, the chroma saturation correction executor first judges whether the input image of each pixel belongs to a chromatic color area, or to an achromatic color area, based on the chroma saturation of each pixel. For example, if the chroma saturation of the input image is smaller than a predetermined value, it can be supposed that the image belongs to the achromatic color area, and if not, the image may belong to the chromatic color area. Therefore, the judging is performed based on this supposition. For pixels judged as an achromatic color area, the chroma saturation correction coefficient of the pixel is increased as the chroma saturation of the pixel increases. The correction coefficient is increased in the range below the standard chroma saturation correction coefficient. For pixels judged as a chromatic color area, the correction coefficient of the pixel is decreased, as the chroma saturation of the pixel increases. The correction coefficient is increased in the range below the standard coefficient. Thus, the maximum value of the chroma saturation correction coefficient of the pixel is equivalent to the standard chroma saturation correction coefficient.

Preferably, the chroma saturation correction executor calculates the chroma saturation correction coefficient classified by color for each pixel, based on the standard chroma saturation correction coefficient and a hue of each pixel. Then, the chroma saturation correction executor calculates the chroma saturation correction coefficients for each pixel, based on the calculated correction coefficient classified by color and the chroma saturation of each pixel. Then the executor performs the correction to the input image, based on the calculated correction coefficient of each pixel.

According to the above image processing apparatus, the chroma saturation correction for each pixel can be performed considering not only the chroma saturation but also the hue in each pixel. According to a conventional image processing apparatus, for example, if a color is flesh color and the chroma saturation is strong in a certain pixel, the image may become an unnatural flesh color, if the same correction as the other pixels is performed. However, according to image processing apparatus of present invention, the correction to each pixel can be suppressed considering the hue and the chroma saturation in each pixel.

Preferably, the chroma saturation correction executor judges whether the input image of each pixel belongs to the chromatic color area, or to the achromatic color area, based on the chroma saturation of each pixel. For pixels judged as the achromatic color area, the chroma saturation correction coefficient of the pixel is increased, as the chroma saturation of the pixel increases. The correction coefficient of the pixel is increased in the range below the chroma saturation correction coefficient classified by color of each pixel. For the pixels judged as a chromatic color area, the chroma saturation correction coefficient of the pixel is made small, as the chroma saturation of the pixel increases. The correction coefficient of the pixel is increased in the range below the correction coefficient classified by color of each pixel. Thus, the largest value of the correction coefficient for each pixel is equivalent to the correction coefficient classified by color.

The image processing program of present invention is a program for operating a computer as an image processing apparatus, which performs a chroma saturation correction of an input image. The program for operating the computer as the image processing apparatus, comprises the following structure:

(a) A chroma saturation distribution properties calculator, for calculating an average and a variation of chroma saturation of the input image,

(b) A chroma saturation correction coefficient calculator for calculating a correction coefficient based on the calculated average and the variation, and,

(c) A chroma saturation correction executor, for performing a chroma saturation correction to the input image based on the calculated chroma saturation correction coefficient.

In other words, the image processing program makes a computer to perform the steps including the following steps:

(i) A first step for calculating an average and a variation of chroma saturation of an input image,

(ii) A second step for calculating the chroma saturation correction coefficient, which is a degree of correction based on the calculated average and the variation, and,

(iii) A third step for executing the correction to the input image based on the calculated correction coefficient.

Preferably, the chroma saturation correction coefficient calculator calculates a standard correction coefficient based on the average and the variation of chroma saturation. The chroma saturation correction executor calculates the chroma saturation correction coefficient for each pixel, based on the chroma saturation of each pixel and the standard correction coefficient. Then, the correction executor executes the chroma saturation correction to input image based on the calculated correction coefficient for each pixel.

In other words, the image processing program further makes a computer calculate the chroma saturation correction coefficient for each pixel, based on a standard chroma saturation correction coefficient and a chroma saturation of each pixel, in the third step mentioned above. Then, the computer executes the correction to the input image for each pixel, based on the calculated correction coefficient for each pixel.

Preferably, the chroma saturation correction coefficient calculator calculates a standard chroma saturation correction coefficient based on an average and a variation of the chroma saturation. The chroma saturation correction executor calculates the chroma saturation correction coefficient classified by color for each pixel, based on the hue of each pixel and the calculated correction coefficient. The executor calculates the chroma saturation correction coefficient of each pixel based on the correction coefficient classified by color, and the chroma saturation of each pixel. Then, the correction executor performs a chroma saturation correction to an input image based on the calculated correction coefficient of each pixel.

In other words, the program makes a computer perform the following steps further in the third step mentioned above:

(i) A step calculating a chroma saturation correction coefficient classified by color of each pixel based on a hue of each pixel and a chroma saturation correction coefficient,

(ii) A step calculating the chroma saturation correction coefficient of each pixel, based on the calculated correction coefficient classified by color and a chroma saturation of each pixel, and,

(iii) A step executing a chroma saturation correction to an input image for each pixel, based on the calculated correction coefficient of each of pixel.

As mentioned above, according to present invention, a chroma saturation correction coefficient is determined according to the properties of chroma saturation distribution of an input image. The correction is performed based on the determined correction coefficient. As a result, a suitable chroma saturation correction can be performed to various input images. Therefore, an image processing apparatus and an image processing program which can generate a natural image is realized.

The features and the advantages of the present invention will be apparent from descriptions of following embodiments.

However, the following embodiments are examples of the present invention. The meaning of present invention or vocabularies of each structure in claims are not restricted to what are indicated in following embodiments.

### BRIEF DESCRIPTION OF THE DRAWINGS

FIG. 1 shows the construction of the image processor which is an embodiment of the present invention.

FIG. 2 shows a hue circle figure for explaining the chroma saturation.

FIG. 3 shows an input chroma saturation histogram. The horizontal axis shows the chroma saturation degree of an input image signal. The vertical axis shows the frequency which is the number of summary pixels of the pixel which takes the same chroma saturation value.

FIG. 4A shows the relationship between the variance of chroma saturation and the maximum value of a chroma saturation correcting gain.

FIG. 4B shows the relationship between the average of chroma saturation, and the standard chroma saturation correcting gain. These relationships are used for calculating the standard chroma saturation correcting gain.

FIG. 5 shows a construction of the image processor which is another embodiment of the present invention.

FIG. 6A shows the relationship between the variance of chroma saturation, and the chroma saturation variance based correcting gain.

FIG. 6B shows the relationship between the average of chroma saturation, and the chroma saturation average based correcting gain. These relationships are used for calculating a standard chroma saturation correcting gain.

FIG. 7 shows a construction of the image processor which is another embodiment of present invention.

FIG. 8 shows the relationship between the chroma saturation and chroma saturation correcting gain which is used for calculating chroma saturation correcting gain for each pixel.

FIG. 9 shows a construction of the image processor which is another embodiment of the present invention.

FIG. 10 shows the relationship between the hue of an input image signal, and the maximum value of the chroma saturation correcting gain classified by color. The relationship is used for calculating the chroma saturation correcting gain for each pixel.

FIG. 11 shows the relationship between the chroma saturation and the chroma saturation correcting gain classified by color. This relationship is used for calculation of the chroma saturation correcting gain for each pixel.

FIG. 12 shows a construction of the image processor of another embodiment of the present invention.

FIG. 13 shows the relationship between the hue of an input picture signal, and the independent chroma saturation correcting gain classified by color. This relationship is used for calculating the chroma saturation correcting gain for each pixel.

FIG. 14 shows an input chroma saturation histogram of an input image, which the chroma saturation is distributed near a chroma saturation average value.

FIG. 15 shows an input chroma saturation histogram of an input image, which the chroma saturation is distributed to a low chroma saturation area and a high chroma saturation area.

### DESCRIPTION OF THE PREFERRED EMBODIMENTS

Hereafter, the embodiments of present invention are explained accompanying the drawings.

(First Embodiment)

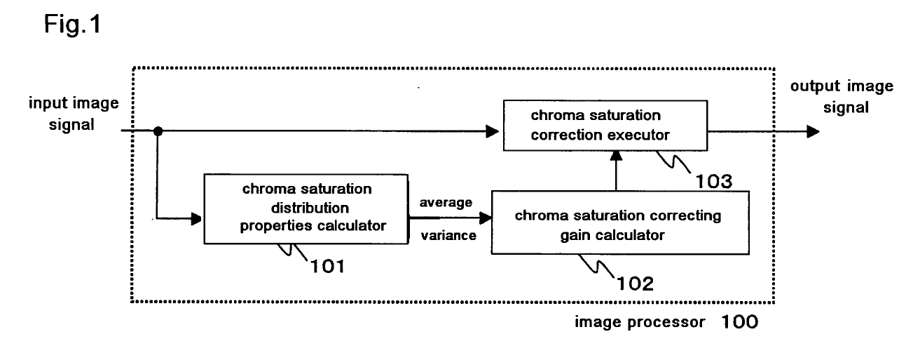

FIG. 1 is a figure showing the construction of the first embodiment of the present invention.

The image processor 100 contains the chroma saturation distribution properties calculator 101, the chroma saturation correcting gain calculator 102, and the chroma saturation correction executor 103 in the construction, as shown in FIG. 1. The chroma saturation distribution properties calculator 101 calculates chroma saturation distribution properties, such as average and variance of the chroma saturation from an input image signal. The chroma saturation correcting gain calculator 102 calculates a standard chroma saturation correcting gain, which is a standard coefficient for calculating a degree of chroma saturation correction, based on the chroma saturation distribution properties of an input image signal. The chroma saturation correction executor 103 corrects the chroma saturation of the input image signal based on the standard chroma saturation correcting gain, and outputs the corrected image signal.

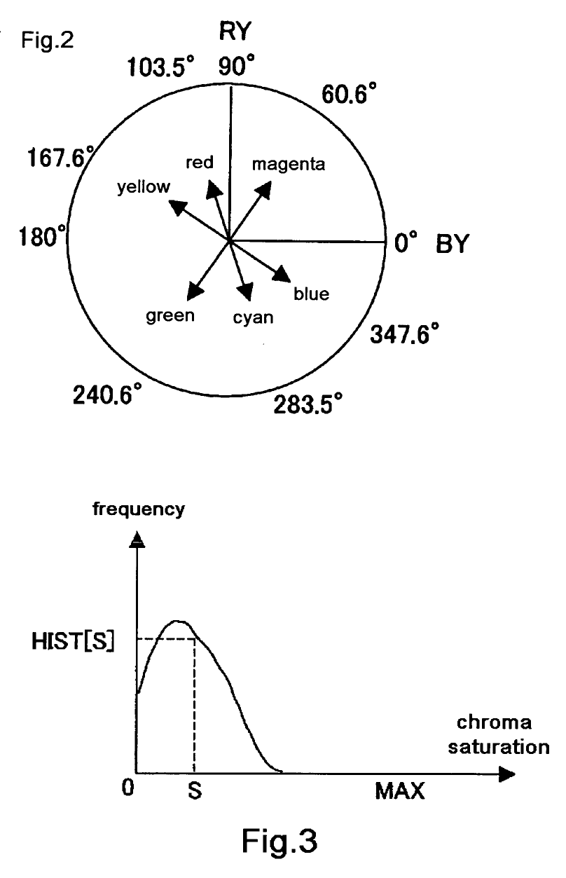

The meaning of the “chroma saturation” is a vividness of color, or color purity. If the chroma saturation is high, it means that the color is pure. If the chroma saturation is low, it means that the color is gray or muddy. A degree of the chroma saturation ranges from 0% to 100%. FIG. 2 shows a hue circle figure. In the figure, hue is shown annularly, and the chroma saturation is shown by length of an arrow. In other words, the chroma saturation value S is calculated by a square root of the sum of the squares of color difference signals RY and BY, as shown in following formula (Eq.1):
S=\sqrt{RY²+BY²} (Eq.1)

The hue expresses a tone, such as red, yellow, green, cyan, blue, and magenta. The hue is shown on the hue circle by angle (0 to 360 degrees) from the color difference signal BY. In other words, hue H can be expressed by an arctangent of RY/BY as shown in following formula (Eq.2):

$$H = {tan}^{- 1} \frac{RY}{BY} \qquad ( Eq . 2 )$$

Hereafter, each structure of the image processor 100 of FIG. 1 is described in detail.

(Chroma Saturation Distribution Properties Calculator 101)

The chroma saturation distribution properties calculator 101 separates a color difference signal from the inputted image signal. The chroma saturation for every pixel is calculated from the separated color difference signal, and the average and the variance of the chroma saturation, are calculated as chroma saturation distribution properties.

FIG. 3 shows a histogram (bar chart) of chroma saturation of the input image signal. In the histogram, the horizontal axis shows the degree of chroma saturation of the input image signal, and the vertical axis shows the frequency, which is the number of summary pixels which take the same chroma saturation value. The chroma saturation distribution properties calculator 101 calculates the chroma saturation average AVE (called “AVE”, hereafter) of the input image signal, and the variance V (called “V”, hereafter) of the input image signal by following formula (Eq.3), when degree of chroma saturation of each pixel ranges from 0 to MAX, the frequency of the pixels having the chroma saturation S is defined as HIST [S], and the total number of pixels are N:

$$AVE = {\sum }_{S = 0}^{MAX} ( S \times HIST [ S ] ) / N \\ V = {\sum }_{S = 0}^{MAX} \{ {( S - AVE )}^{2} \times HIST [ S ] \} / N \qquad ( Eq . 3 )$$

(Standard Chroma Saturation Correcting Gain Calculator 102)

The standard chroma saturation correcting gain calculator 102 calculates the standard chroma saturation correcting gain Gs (called “Gs”, hereafter) based on AVE and V which were calculated by the chroma saturation distribution properties calculator 101.

Specifically, the standard chroma saturation correcting gain calculator 102 calculates Gm, which is the maximum value Gs can take, based on a function prescribing a relationship between V and Gm (hereafter ,the function is called “V-Gm function”).

Next, Gs is calculated based on a function prescribing a relationship between AVE and Gs (hereafter the function is called “AVE-Gs function”). This AVE-Gs function can be prescribed based on Gm calculated from the V-Gm function.

By the way, it can be supposed that an input image signal in which AVE is extremely small is an image which is rather achromatic. If a strong chroma saturation correction is applied to such an image, an unnatural image may be obtained, because some color may be attached to the image.

Moreover, it can be supposed that an input image with large AVE is an image which is rather chromatic. If a strong chroma saturation correction is applied to such an image, an unnatural color may be attached to the image, because of the color crushing.

On the other hand, variance V expresses the convergence or the scatter of the chroma saturation from the chroma saturation average. Therefore, it can be supposed that an input image signal having an extremely small V is an image whose chroma saturation distribution (or histogram) is extremely concentrated near the average. If a strong chroma saturation correction is applied to such an image, an unnatural image may be obtained, because the noise in the image is emphasized.

On the other hand, it can be supposed that an input image signal having an extremely large V is an image whose chroma saturation distribution is not concentrated in a certain area, but is scattered. If a strong chroma saturation correction is applied to such an image, an unnatural color may be obtained, because the color may be crushed in pixels having high chroma saturation.

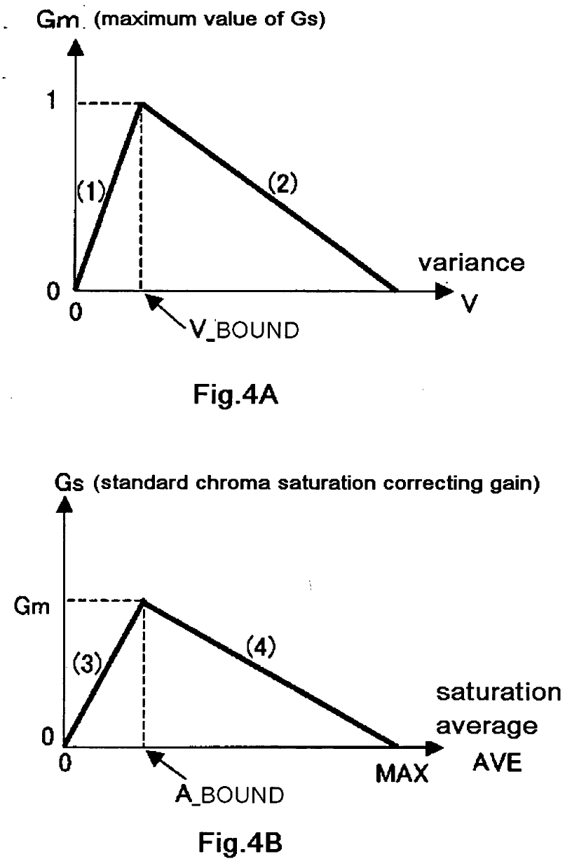

Supposing above characteristics of input images, in the image processor 100, the standard chroma saturation correcting gain calculator 102 calculates Gs based on the V-Gm function and AVE-Gs function, which have properties as shown in FIG. 4A and FIG. 4B respectively.

FIG. 4A shows an example graph of a V-Gm function. Here, the horizontal axis shows V and the vertical axis shows Gm. In this embodiment, the maximum value of Gm is set to 1.

In V-Gm function, a boundary value of V between a small variance area and a large variance area is prescribed as V_BOUND. It is prescribed that in the segment (1), namely where V satisfies V<V_BOUND, Gm decreases sharply, as V decreases.

If V satisfies V=V_BOUND, Gm is maximized. In the segment (2), namely where V satisfies V>V_BOUND, Gm decreases gradually rather than the case of the segment (1), as the V increases.

FIG. 4B shows an example graph of an AVE-Gs function. Here, the horizontal axis shows AVE and the vertical axis shows Gs. The maximum value of Gs is Gm, which is determined by the V-Gm function.

In AVE-Gs function, a boundary chroma saturation average value of the achromatic color image area and the chromatic color image area is prescribed as AVE_BOUND. The area where AVE satisfies AVE<AVE_BOUND is prescribed as the achromatic color image area. In segment (3), namely where AVE satisfies AVE<AVE_BOUND, Gs decreases sharply as the AVE decreases.

Gs is maximized if AVE satisfies AVE=AVE_BOUND. In segment (4), where AVE satisfies AVE>AVE_BOUND, it is prescribed that Gs decreases gradually rather than the case of segment (3), as the AVE increases.

Summarizing the above, the V-Gm function is prescribed as follows:
When V=0: Gm is at the minimum value 0.
When 0<V<V_BOUND: Gm is in a steep upward slant to the right line.
When V=V_BOUND: Gm is at the maximum value 1.
When V_BOUND<V: Gm is in a gradually sloping right decreasing line.

The AVE-Gs function is prescribed as follows:
When AVE=0: Gs is at the minimum value 0.
When 0<AVE<AVE_BOUND: Gs is in a steep upward slant to the right line.
When AVE=AVE_BOUND: Gs is at the maximum value Gm.
When AVE_BOUND<AVE: Gs is in a gradually sloping right decreasing line.

When it can be considered that the input image signal belongs to an achromatic color area, the image processor 100 can calculate Gs, so as to apply a weak chroma saturation correction when the input image approaches the achromatic image (i.e. when the chroma saturation distribution of the image separates from a predetermined value) by using the V-Gm function and the AVE-Gs function which are mentioned above.

When it can be supposed that an input image signal belongs to a chromatic color area, the image processor 100 can calculate Gs, so as to apply a weak chroma saturation correction when the chroma saturation average of the input image signal increases (i.e. when the chroma saturation distribution of the image separates from a predetermined value).

(Chroma Saturation Correction Executor 103)

The chroma saturation correction executor 103 first calculates a chroma saturation correction quantity by multiplying Gs and input color difference signal for each pixel, and then generates an output image signal by adding said correction quantity to input color difference signal for each pixel.

For example, if RY [n] and BY [n] stands for input color difference signals in pixel n, and RYOUT [n] and BYOUT [n] stands for the color difference signal in pixel n after the correction, the RYOUT [n] and the BYOUT [n] can be calculated by Eq.4:
RYOUT[n]=RY[n](1+Gs)
BYOUT[n]=BY[n](1+Gs) (Eq.4)

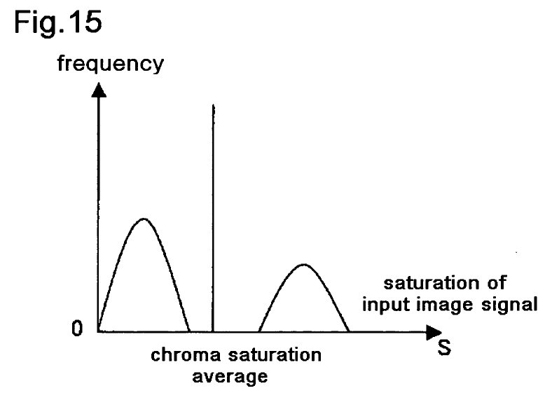

Conventionally, an unsuitable correction might be executed for an input image signal having properties like FIG. 15. However, according to this chroma saturation correction executor 103, a suitable correction can be performed and can acquire a natural image signal.

In this first embodiment described above, the V-Gm function and the AVE-Gs function are prescribed by the combination of proportion lines. The inclination of the line may be changed according to the properties of the input image signal etc. Moreover, those functions may be prescribed by the combination of functions, such as logarithm curve or quadratic curves.

(Second Embodiment)

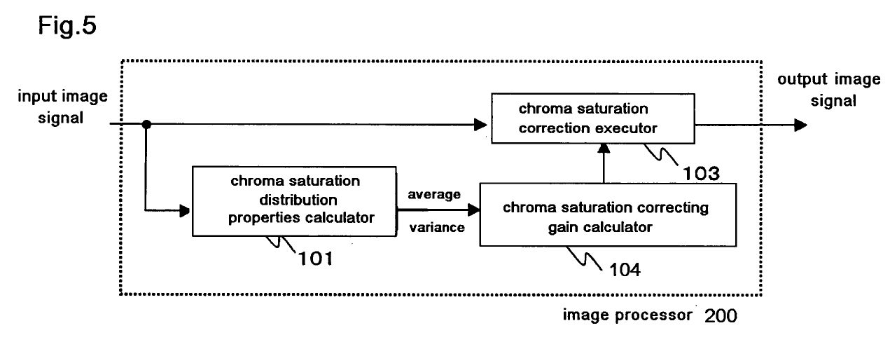

FIG. 5 is a figure showing the construction of the second embodiment of the present invention.

The image processor 200 includes the chroma saturation distribution properties calculator 101, the standard chroma saturation correcting gain calculator 104, and the chroma saturation correction executor 103 in its construction, as shown in FIG. 5.

Hereafter, each structure included in the image processor 200 of FIG. 5 is described in detail. Descriptions are omitted for the chroma saturation distribution properties calculator 101 and the chroma saturation correction executor 103, because they perform similar processes as in the case of the first embodiment.

(Standard Chroma Saturation Correcting Gain Calculator 104)

The standard chroma saturation correcting gain calculator 104 calculates Gs based on AVE and V which were calculated by chroma saturation distribution properties calculator 101.

Concretely, the standard chroma saturation correcting gain calculation part 104 first calculates a chroma saturation variance based correcting gain Gv, which is one coefficient for calculating Gs, using a predetermined function prescribing a relationship between V and Gv (hereafter the function is called “V-Gv function”).

Next, a chroma saturation average based chroma saturation correcting gain Ga (hereafter called “Ga”), which is another coefficient for calculating Gs, using a predetermined function prescribing a relationship between AVE and Ga (hereafter the function is called “AVE-Ga function”).

Next, Gs is calculated by multiplying by Gv and Ga, as shown in following formula (Eq.5):
Gs=Gv×Ga (Eq.5)

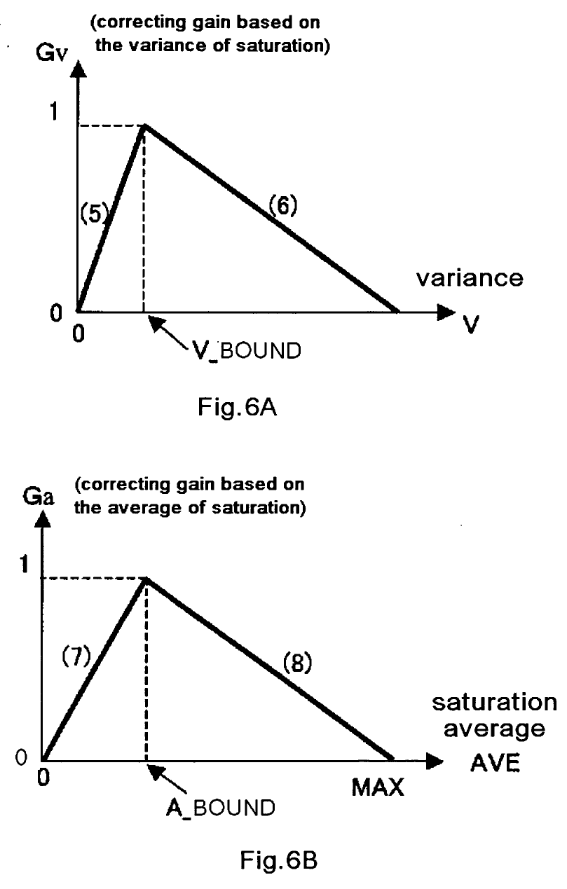

The V-Gv function and the AVE-Ga function are prescribed, as shown in FIG. 6A and FIG. 6B, respectively.

FIG. 6A shows an example graph of the V-Gv function. The horizontal axis shows V and the vertical axis shows Gv. The maximum value of Gv is set to 1 in this second embodiment.

The V-Gv function has the similar properties as V-Gm function which is indicated in the first embodiment (FIG. 4A).

FIG. 6B shows an example graph of the AVE-Ga function. The horizontal axis shows AVE and the vertical axis shows Ga. The maximum value of Ga is set to 1 in this second embodiment.

The AVE-Ga function has the similar properties as the AVE-Gs function indicated in the first embodiment (FIG. 4B), except the maximum value being 1.

By using above indicated standard chroma saturation correcting gain calculator 104, a similar effect as the first embodiment can be acquired.

Third Embodiment

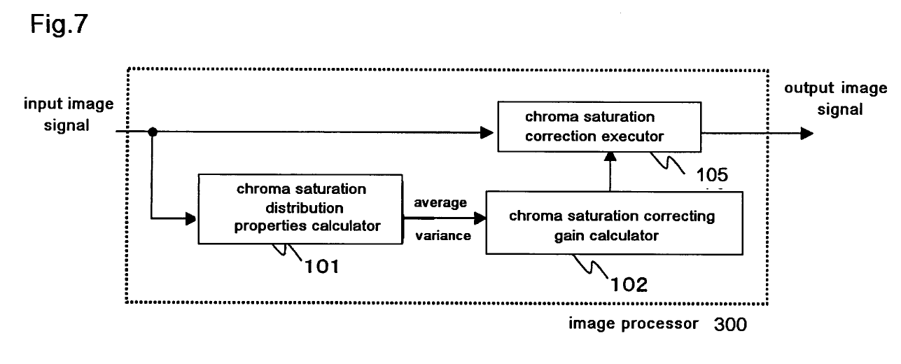

FIG. 7 shows the construction of the third embodiment of the present invention.

The image processor 300 includes the chroma saturation distribution properties calculator 101, the standard chroma saturation correcting gain calculator 102, and the chroma saturation correction executor 105 in its construction, as shown in FIG. 7.

Hereafter, each construction included in the image processor 300 of FIG. 7 is explained in detail. Descriptions of the chroma saturation distribution properties calculator 101 and the standard chroma saturation correcting gain calculator 102 are omitted, because they perform similar processes as in the case of the first embodiment.

Chroma Saturation Correction Executor 105

The chroma saturation correction executor 105 calculates a coefficient for calculating a chroma saturation correction quantity, which is based on chroma saturation of input image signal, for each pixel (the coefficient is hereafter called “chroma saturation correcting gain”).

The chroma saturation correction executor 105 calculates the chroma saturation correcting gain G (hereafter called just “G”) for each pixel, based on Gs and chroma saturation of input image signal in each pixel. Here, the chroma saturation correction executor 104 keeps G not to exceed Gs. Concretely, the chroma saturation correction executor 105 calculates G for each pixel based on a predetermined function prescribing the relationship between chroma saturation S and G (the function is hereafter called “S-G function”).

By the way, when the input image has small chroma saturation, it can be supposed that the image is an achromatic image. If a strong chroma saturation correction is applied for such an image, some color may be attached, and the image may become unnatural.

On the other hand, if a strong chroma saturation correction is applied for an image having large chroma saturation, some color may be crushed, or some unnatural color may be obtained.

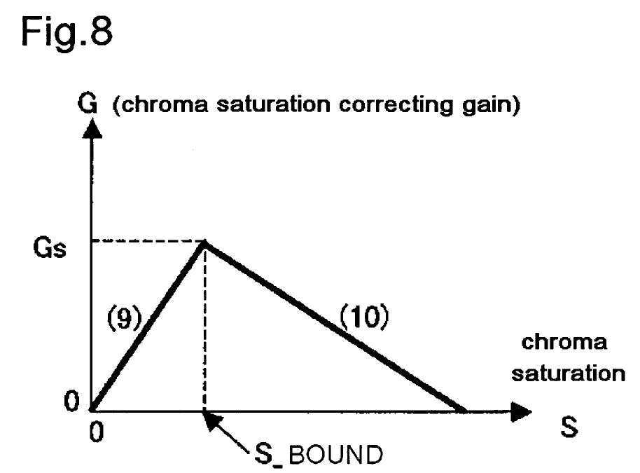

Supposing the above characteristics of the input signals, the chroma saturation correction executor 105 of the image processor 300 calculates G for each pixel based on the S-G function, as shown in FIG. 8.

FIG. 8 is an example graph of the S-G function. The horizontal axis shows saturation S and the vertical axis shows G. The maximum value of G is Gs, which is calculated in the standard chroma saturation correcting gain calculator 102.

In S-G function, it is prescribed that the boundary chroma saturation value of the achromatic color area and the chromatic color area is S_BOUND, and is prescribed that the area where S satisfies S <S_BOUND is an achromatic color area. Also, it is defined that in segment (9), where S satisfies S <S_BOUND, G decreases sharply as S decreases.

Moreover, in S-G function, it is prescribed that when S is equal to S_BOUND, G takes the maximum value Gs, and is prescribed that in segment (10), where S satisfies S>S_BOUND, G decreases gradually rather then the case of segment (9) as the S increases.

Summarizing the above, the S-G function is prescribed that,
When S=0: G is the minimum value 1
When 0<S<S_BOUND: G is in a steep upward slant to the right line
When S=S_BOUND: G is the maximum value Gs
When S_BOUND<S: G is in a gradually sloping right decreasing line.

Next, the chroma saturation correction executor 105 first calculates chroma saturation correction quantity, which is obtained by multiplying an input color difference signal and chroma saturation correcting gain. Then, the obtained quantity is added to the input color difference signal to generate an output image signal.

Concretely, if RY [n] and BY [n] stands for input color difference signals in pixel n, G [n] stands for chroma saturation correcting gain in each pixel, and RYOUT [n] and BYOUT[n] stands for color difference signals in each pixel after correction, the RYOUT [n] and the BYOUT [n] are calculated by Eq.6:
RYOUT [n]=RY [n](1 +G[n])
BYOUT [n]=BY ]n](1 +G[n]) (Eq.6)

As mentioned above, in the image processor 300 of this embodiment, the chroma saturation correction executor 105 suppresses the amount of Gs according to chroma saturation of an input image signal for each pixel.

In other words, for a pixel where it can be supposed that the chroma saturation belongs to an achromatic color area, the chroma saturation correction executor 105 calculates G so as to weaken the chroma saturation correction when chroma saturation decreases, based on the S-G function prescribed above.

When the chroma saturation belongs to a chromatic color area, but in a comparatively low chroma saturation area, G is set to about the same amount as Gs, in order to apply a stronger correction.

For a pixel where it can be supposed that the chroma saturation belongs to the chromatic color area, G is calculated so that the correction may be weakened, as the chroma saturation increases.

By performing such a chroma saturation correction, color crushing and unnatural coloring can be suppressed for each pixel, and can achieve. more exact half toning.

In this embodiment, the chroma saturation correction executor 105 prescribes S-G function by combination of proportion lines. The inclination of those lines may be changed according to the correction result. Moreover, the function may be prescribed by combination of logarithm curves, or quadratic curves, instead of proportion lines.

The standard chroma saturation correcting gain calculator 102 may be replaced by the standard chroma saturation correcting gain calculator 104 which is used in the second embodiment.

(Fourth Embodiment)

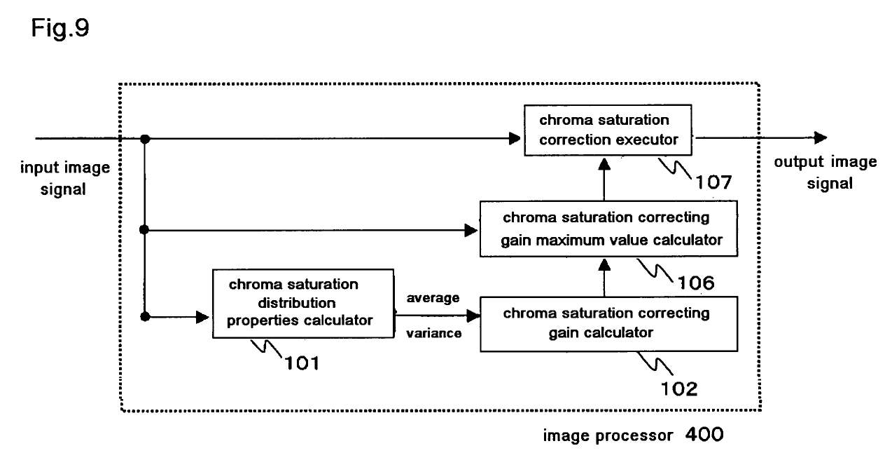

FIG. 9 shows a construction of the fourth embodiment of the present invention.

The image processor 400 includes the chroma saturation distribution properties calculator 101, the standard chroma saturation correcting gain calculator 102, the chroma saturation correcting gain maximum value calculator 106, and the chroma saturation correction executor 107 in its construction, as shown in FIG. 9.

Hereafter, each construction included in the image processor 400 of FIG. 9 is described in detail.

Descriptions of the chroma saturation distribution properties calculator 101 and the standard chroma saturation correcting gain calculator 102 are omitted because they perform the similar processes as in the case of the first embodiment of the present invention.

(Chroma Saturation Correcting Gain Maximum Value Calculator 106)

The chroma saturation correcting gain maximum value calculator 106 separates a color difference signal from the input image signal, and calculates a hue from the separated color difference signal. Then, the maximum value of SG is calculated for every pixel. Here, “SG” stands for “chroma saturation correcting gain classified by color”, which is a coefficient for calculating the chroma saturation correction quantity based on the hue of the input image signal.

Concretely, the chroma saturation correcting gain maximum value calculator 106 calculates SGm, which is the maximum value of SG for each pixel, based on a function prescribing a relationship between hue H of an input image signal, and SGm (hereafter the function is called “H-SGm function”).

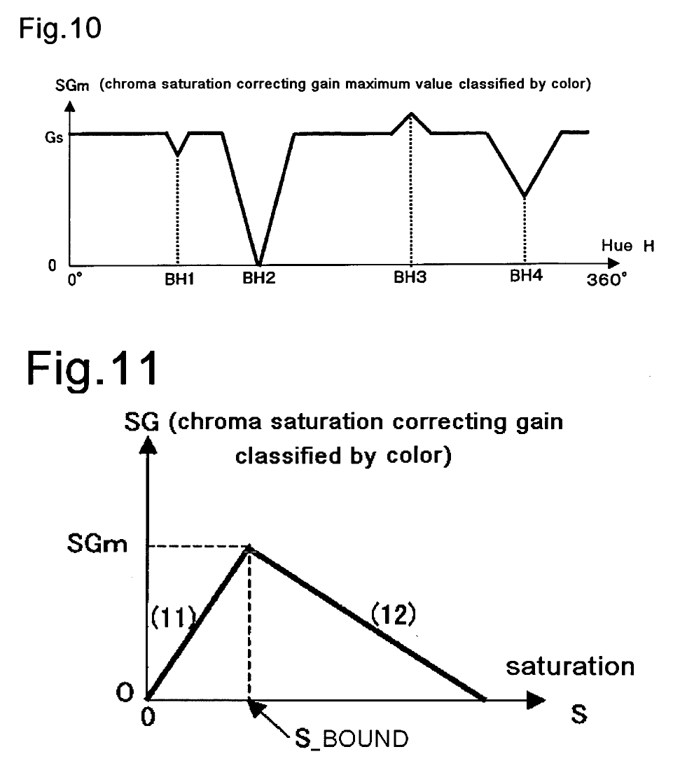

FIG. 10 shows an example graph of the H-SGm function. The horizontal axis shows H of an input image signal, and the vertical axis shows the SGm.

In the H-SGm function, Gs is set as the standard value for SGm. In a specific hue such as in hue of BH1, BH2, BH3, and BH4, the SGm is set to larger or smaller value than the Gs. Therefore, for specific colors such as flesh color, which an unnatural color may be obtained if the same chroma saturation correction as the other colors is performed, the chroma saturation correction can be weakened by setting SGm smaller for hue which corresponds to the specific color.

(Chroma Saturation Correction Executor 107)

The chroma saturation correction executor 107 calculates the SG for each pixel based on SGm of each pixel, and the chroma saturation of the input image signal of each pixel. Here, the chroma saturation correction executor 107 suppresses SG not to exceed SGm.

Concretely, the chroma saturation correction executor 107 calculates SG for each pixel based on a predetermined function prescribing a relationship between the chroma saturation S and SG (the function is hereafter called “S-SG function”).

FIG. 11 shows an example graph of the S-SG function. The horizontal axis shows the chroma saturation S and the vertical axis shows SG. The maximum value of SG is equal to SGm, which is calculated in the chroma saturation correcting gain maximum value calculator 106.

The S-SG function has the similar properties as the S-G function indicated in the third embodiment (FIG. 8), except the maximum value is SGm.

The chroma saturation correction executor 107 first calculates the chroma saturation correction quantity by multiplying an input color difference signal and the SG, then adds the calculated correction quantity to the color difference signal for every pixel, to generate an output image signal.

Concretely, if RY [n] and BY [n] stands for input color difference signals of each pixel, SG [n] stands for chroma saturation correcting gain classified by color in pixel n, and RYOUT [n] and BYOUT [n] stands for color difference signals of each pixel after the chroma saturation correction, the RYOUT [n] and BYOUT [n] are calculated by Eq.7. Here, n expresses the number which identifies each pixel and is a positive whole number.
RYOUT [n]=RY [En](1+SG[n])
BYOUT [n]=BY [n](1+SG[n]) (Eq.7)

As mentioned above, in the image processor 400 in this fourth embodiment, the chroma saturation correcting gain maximum value calculator 106 and the chroma saturation correction executor 107, strengthen or weaken the chroma saturation correction considering also the hue of the input image signal, for each pixel.

By the way, there are some specific colors, such as flesh color, which people have memorized well. If the same correction as other colors is applied to such a flesh color, some unnatural color maybe output. However, according to the chroma saturation correction of this embodiment, such phenomena can be avoided by suppressing the correction to the specific color, and can perform a more natural correction.

(Fifth Embodiment)

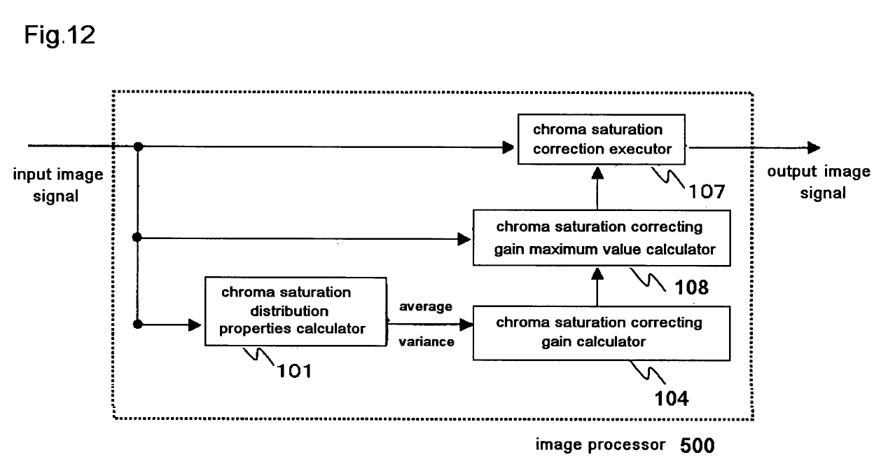

FIG. 12 shows a construction of the fifth embodiment of present invention.

The image processor 500 includes the chroma saturation distribution properties calculator 101, the standard chroma saturation correcting gain calculator 104, the chroma saturation correcting gain maximum value calculator 108, and the chroma saturation correction executor 107 in its construction, as shown in FIG. 12.

Hereafter, the constructions included in the image processor 500 of FIG. 12 are described in detail.

The chroma saturation distribution properties calculator 101, the standard chroma saturation correcting gain calculator 104, and the chroma saturation correction executor 107 perform the similar processes as in the case of the second embodiment and the fourth embodiment. Therefore, explanations for those are omitted.

(Chroma Saturation Correcting Gain Maximum Value Calculator 108)

The chroma saturation correcting gain maximum value calculator 108 calculates SGm for every pixel.

Concretely, the chroma saturation correcting gain maximum value calculator 108 first calculates CG (CG stands for “independent chroma saturation correcting gain classified by color”, and is a coefficient for calculating SGm) for every pixel, based on a function prescribing a relationship between the hue H of an input image signal and the CG (the function is hereafter called a “H-CG function”).

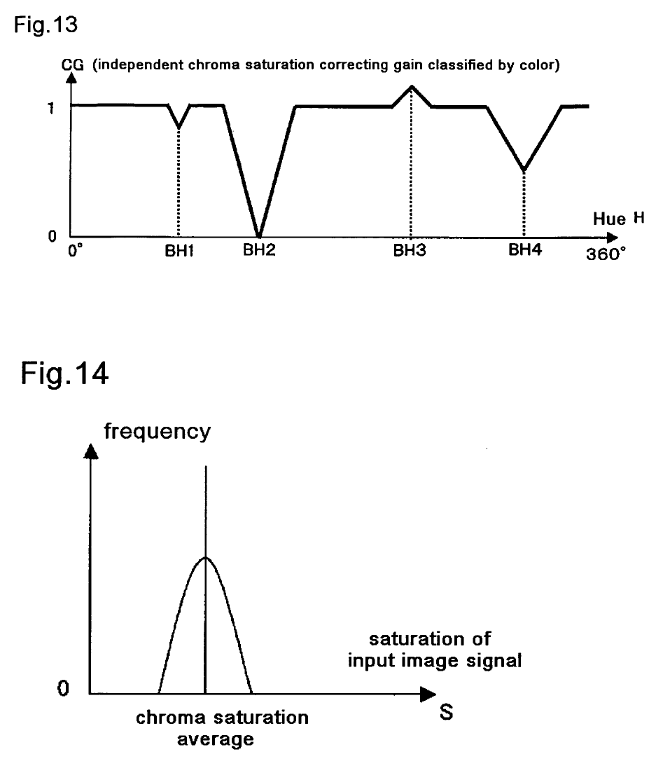

FIG. 13 shows an example graph of the H-CG function. The horizontal axis shows H of an input image signal, and the vertical axis shows the CG.

In the H-CG function, 1 is set as a standard value for CG. The CG is set to larger or smaller value than 1 for specific hue such as hue of BH1 to BH4.

Next, as shown in Eq.8, SGm of each pixel is acquired by multiplying Gs by CG for each pixel. Here, in Eq.8, n expresses the number identifying the pixel and is positive whole number:
SGm[n]=Gs×CG[n] (Eq.8)

By using the chroma saturation correcting gain maximum value calculator 108 of this embodiment, the similar effect or feature as the fourth embodiment can be acquired.

In the above, each embodiments of present invention were described in detail. Note that the scope of the present invention is not intended to be limited to the above mentioned embodiment. The embodiment of the present invention may be suitably and variously changed within the range of the technical idea shown in the appended claims.

For example, in each embodiment mentioned above, the average and the variation of chroma saturation of the input images are calculated based on an arithmetical mean. However, these may be calculated using a median value of the chroma saturation, or a mode of the chroma saturation.

Moreover, in V-Gm function and V-Gv function mentioned above, boundary of the small chroma saturation variance area and the large variance area is prescribed only by one predetermined value V_BOUND. However, the boundary may be prescribed as an area with a certain width.

Similarly, in the AVE-Gs function, the AVE-Ga function, and the S-G function mentioned above, the boundary of the achromatic color image area and the chromatic color image area is prescribed only by a single predetermined value AVE_BOUND or S_BOUND. However, the boundary may be prescribed as an area with a certain width respectively.

Furthermore, each structure of the image processor shown in FIG. 1, FIG. 5, FIG. 7, FIG. 9, and FIG. 12 may be realized by hardware, such as central processing unit of arbitrary computers, memory, the other large scale integrated circuits, etc. By software, the construction may be realized by a program (an image processing program) loaded into a memory. Needless to say, it may be realized by combining hardware and software.

Moreover, the image processor of the present invention is applicable to graphic displays in general, such as liquid crystal displays or plasma displays, etc. In addition, the image processor is applicable to digital cameras, digital video cameras, etc.

1. An image processing apparatus performing a chroma saturation correction of an input image, comprising:
(a) a chroma saturation distribution properties calculator, for calculating an average and a variation of the chroma saturation of the input image;
(b) a chroma saturation correction coefficient calculator, for calculating a chroma saturation correction coefficient, based on the average and the variation of the chroma saturation; and
(c) a chroma saturation correction executor, for executing a chroma saturation correction to the input image, based on the chroma saturation correction coefficient.

2. The apparatus of claim 1, wherein, the chroma saturation correction coefficient calculator,
calculates a first coefficient, based on the variation of the chroma saturation,
calculates a second coefficient, based on the average of said chroma saturation, and
calculates a chroma saturation correction coefficient, based on the first coefficient and the second coefficient.

3. The apparatus of claim 2, wherein,
the chroma saturation correction coefficient calculator decreases the first coefficient, as the variation of chroma saturation increases, when said variation is beyond a predetermined value.

4. The apparatus of claim 2, wherein, the chroma saturation correction coefficient calculator,
judges whether the input image belongs to a chromatic color area or to an achromatic color area based on the average of the chroma saturation,
increases the second coefficient as the average of the chroma saturation increases, when the input image is judged to belong to an achromatic color area, and
decreases the second coefficient as the average of the chroma saturation increases, when the input image is judged to belong to a chromatic color area.

5. The apparatus of claim 2, wherein, the chroma saturation correction coefficient calculator determines a
maximum degree of the second coefficient based on the first coefficient.

6. The apparatus of claim 2, wherein,
(i) the chroma saturation correction coefficient calculator calculates a standard chroma saturation correction coefficient, based on the average of the chroma saturation and the variation of the chroma saturation; and
(ii) the chroma saturation correction executor,
calculates a chroma saturation correction coefficient for each pixel based on the chroma saturation of each pixel and the standard chroma saturation correction coefficient, and
executes a chroma saturation correction to the input image, based on said chroma saturation correction coefficient for each pixel.

7. The apparatus of claim 6, wherein,
the chroma saturation correction executor,
judges whether each of pixel of the input image belongs to a chromatic color area or to an achromatic color area,
increases the chroma saturation correction coefficient in the range below the standard chroma saturation correction coefficient as the chroma saturation of the pixel increases, for the pixel judged to belong to the achromatic color area, and
decreases the chroma saturation correction coefficient in the range below the standard chroma saturation correction coefficient as the chroma saturation of the pixel increases, for the pixel judged to belong to the chromatic color area.

8. The apparatus of claim 1, wherein,
(i) the chroma saturation correction coefficient calculator calculates a standard chroma saturation correction coefficient based on an average of the chroma saturation, and the variation of a chroma saturation,
(ii) the chroma saturation correction executor,
calculates the chroma saturation correction coefficient classified by color for each pixel based on the hue of the chroma saturation correction coefficient of each pixel and the standard chroma saturation correction coefficient,
calculates the chroma saturation correction coefficient for each pixel based on the chroma saturation correction coefficient classified by color for each pixel and the chroma saturation correction coefficient for each pixel, and
executes a chroma saturation correction based on the calculated chroma saturation correction coefficient for each calculated pixel.

9. The apparatus of claim 8, wherein,
the chroma saturation correction executor,
judges whether each pixel of the input image belongs to a chromatic color area or to an achromatic color area based on the chroma saturation of each of the pixel,
increases the chroma saturation correction of the pixel as the chroma saturation of the pixel increases, in the range below the chroma saturation correction coefficient classified by color for each pixel, for the pixel judged to belong to the achromatic color area, and
decreases the chroma saturation correction of the pixel as the chroma saturation of the pixel increases, in the range below the chroma saturation correction coefficient classified by color for each pixel, for the pixel judged to belong to the chromatic color area.

10. An image processing program, for operating a computer as an image processing apparatus performing chroma saturation correction of an input image, comprising:
(a) a chroma saturation distribution properties calculator, for calculating an average and a variation of a chroma saturation of the input image;
(b) a chroma saturation correction coefficient calculator, for calculating a chroma saturation correction coefficient, based on the average and the variation of the chroma saturation; and
(c) a chroma saturation correction executor, for performing a chroma saturation correction to the input image based on the chroma saturation correction coefficient.

11. The program of claim 10, wherein,
(i) the chroma saturation correction coefficient calculator calculates a standard chroma saturation correction coefficient based on an average of the chroma saturation and the variation of the chroma saturation, and
(ii) the chroma saturation correction executor
calculates a chroma saturation correction coefficient for each pixel, based on the chroma saturation of each pixel and the standard chroma saturation correction coefficient, and
executes the chroma saturation correction to the input image based on the chroma saturation correction coefficient for each pixel.

12. The program of claim 10, wherein,
(i) the chroma saturation correction coefficient calculator calculates a standard chroma saturation correction coefficient based on an average of the chroma saturation and the variation of a chroma saturation, and
(ii) the chroma saturation correction executor
calculates the chroma saturation correction coefficient classified by color for each pixel based on the hue of the chroma saturation correction coefficient of each pixel and the standard chroma saturation correction coefficient,
calculates the chroma saturation correction coefficient for each pixel based on the chroma saturation correction coefficient classified by color for each pixel and the chroma saturation correction coefficient for each pixel, and
executes a chroma saturation correction based on said calculated chroma saturation correction coefficient for each calculated pixel.
